(19) United States
(12) Patent Application Publication
(10) Pub. No.: US 2015/0262428 A1
(43) Pub. Date: Sep. 17, 2015

(54) HIERARCHICAL CLUSTERING FOR VIEW MANAGEMENT AUGMENTED REALITY

(71) Applicant: QUALCOMM Incorporated, San Diego, CA (US)

(72) Inventors: Markus Tatzgern, Graz (AT); Denis Kalkofen, Graz (AT); Dieter Schmalstieg, Graz (AT); Raphael David Andre Grasset, Graz (AT)

(21) Appl. No.: 14/640,981

(22) Filed: Mar. 6, 2015

Related U.S. Application Data
(60) Provisional application No. 61/954,549, filed on Mar. 17, 2014.

(51) Int. Cl. G06T 19/00; G06T 7/00; G06T 17/00

(52) U.S. Cl. CPC G06T 19/006; G06T 17/005; G06T 7/0085; G06T 7/004; G06T 2219/004; G06T 2210/61

(57) ABSTRACT

Methods, systems, computer-readable media, and apparatuses for hierarchical clustering for view management in augmented reality are presented. For example one disclosed method includes the steps of accessing point of interest (POI) metadata for a plurality of points of interest associated with a scene; generating a hierarchical cluster tree for at least a portion of the POIs; establishing a plurality of subdivisions associated with the scene; selecting a plurality of POIs from the hierarchical cluster tree for display based on an augmented reality (AR) viewpoint of the scene, the plurality of subdivisions, and a traversal of at least a portion of the hierarchical cluster tree; and displaying labels comprising POI metadata associated with the selected plurality of POIs, the displaying based on placements determined using image-based saliency.

### CROSS-REFERENCE TO RELATED APPLICATION

This application claims the benefit of U.S. Provisional Application No. 61/954,549, filed Mar. 17, 2014, entitled “Hierarchical Clustering for View Management in Augmented Reality,” which is incorporated herein by reference in its entirety.

### BACKGROUND

Computing devices function as a source of information for a user. Many interfaces or representations for information from a computing device have display screens which purely focus on presenting a user with information which is unrelated to the surroundings of a user, such as a list of search results.

Augmented reality (AR) refers to interfaces and displays which provide information to a user in the context of the user's environment. For example, augmented reality systems may provide information to a user about the user's surroundings as a complement to a user's natural vision or hearing.

### BRIEF SUMMARY

Examples for hierarchical clustering for view management in augmented reality are described. One disclosed method includes the steps of accessing point of interest (POI) metadata for a plurality of points of interest associated with a scene; generating a hierarchical cluster for at least a portion of the POIs; establishing a plurality of subdivisions associated with the scene; selecting a plurality of POIs from the hierarchical cluster for display based on an augmented reality (AR) viewpoint of the scene, the plurality of subdivisions, and a traversal of at least a portion of the hierarchical cluster; and displaying labels comprising POI metadata associated with the selected plurality of POIs, the displaying based on placements determined using image-based saliency. In another example, a computer-readable medium comprises program code configured to cause a processor to execute such a method.

These illustrative examples are mentioned not to limit or define the scope of this disclosure, but rather to provide examples to aid understanding thereof. Illustrative examples are discussed in the Detailed Description, which provides further description. Advantages offered by various examples may be further understood by examining this specification.

### BRIEF DESCRIPTION OF THE DRAWINGS

Aspects of the disclosure are illustrated by way of example. The accompanying drawings, which are incorporated into and constitute a part of this specification, illustrate one or more certain examples and, together with the description of the example, serve to explain the principles and implementations of the certain examples.

FIGS. 1A-B show examples of augmented reality views;

FIGS. 2A-B illustrates aspects of hierarchical cluster view management for augmented reality according to one example;

FIG. 3 shows an example method of hierarchical clustering for view management with augmented reality;

FIG. 4A illustrates aspects of an environment that may be augmented as part of an augmented reality system according to certain examples;

FIG. 4B illustrates aspects of a cluster tree according to one example;

FIG. 4C illustrates a display including all possible nodes as part of an augmented reality view according to certain examples;

FIG. 4D illustrates a display including selected nodes as part of an augmented reality view according to certain examples;

FIG. 5A illustrates aspects of a cluster tree according to one example;

FIG. 5B illustrates a display including selected nodes as part of an augmented reality view according to certain examples;

FIG. 6A illustrates aspects of a cluster tree according to one example;

FIG. 6B illustrates a display including selected nodes as part of an augmented reality view according to certain examples;

FIGS. 6C-E illustrates examples of dynamically generating tiles as a part of an augmented reality view according to certain examples;

FIG. 7A illustrates aspects of a cluster tree according to one example;

FIG. 7B illustrates a display including selected nodes as part of an augmented reality view according to certain examples;

FIGS. 8A-C illustrate nodes for a cluster tree according to one example.

FIG. 9 shows an example of a computing device for hierarchical clustering for view management in augmented reality;

FIG. 10 shows an example device for hierarchical clustering for view management in augmented reality;

FIG. 11 shows an example of a head-mounted device for hierarchical clustering for view management in augmented reality; and

FIG. 12 shows an example network that may be used in conjunction with various suitable devices or systems for hierarchical clustering for view management in augmented reality.

### DETAILED DESCRIPTION

Examples are described herein in the context of hierarchical clustering for view management in augmented reality. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

Devices such as digital cameras, phones with embedded cameras, or other camera or sensor devices may be used to identify and track objects in three-dimensional (3D) environments. This may be used to create augmented reality displays where information about objects recognized by a system may be presented to a user that is observing a display of the system. Such information may be presented on an overlay of the real environment in a device's display.

Depending on the environment represented by the display, certain problems may arise with augmented reality. If the amount of information or the number of POIs associated with a certain environment are too large, then the view displayed may become cluttered, and the supplemental information presented by the augmented reality interface or browser may overwhelm other information which may be more important. Additionally, depending on the interface, certain information may interfere with other information. Occlusion of both annotations presented as part of the augmented reality and occlusion of the background or real word details may thus be a problem. Further problems may arise when simple filtering by category, tags, or distance from a user makes hidden information disappear completely. Also, the spatial relation to the real world for augmented reality information may be a problem because data points or augmented reality information may not relate to visible POIs.

Various examples may ameliorate or remove these issues from an augmented reality system by providing automatic clutter avoidance. Examples may also provide a “semantic level of detail” where a user may drill down to additional information using a browser interface or other commands. Additionally, examples may combine advantages of ranked search and free viewpoint exploration to improve the presentation of information as part of an augmented reality system.

An augmented reality system as discussed herein may refer to information presented to a user through a wearable headset with glasses on a view taken by a camera of a smartphone, tablet device, laptop computer, phablet, or any other such device. The augmented reality system may use sensor information to represent the real world, and then provide information on POIs as part of an output to the user.

### Illustrative Example of Hierarchical Clustering for View Management in Augmented Reality

Different types of augmented reality systems can display information to a user viewing a scene through a camera, a heads-up display, or even wearable items, like glasses equipped with display equipment, e.g., a projector that can project images onto the lenses or with an ancillary display-capable lens. In an illustrative example of an augmented reality system, a user captures a real-time scene using a camera on a smartphone and views the scene on the smartphone's display. The smartphone processes the image information received from the camera, identifies points of interest (POIs), and generates and displays information related to some of the POIs overlaid on the scene. The user is then able to view that information and gain knowledge about the scene that may not otherwise be apparent from simply viewing the scene itself.

In this illustrative example, the smartphone is configured to generate and display augmented information (or augmented reality information) in a way to provide additional information to the user while attempting to avoid cluttering the screen with too much augmented information or without obscuring the POIs themselves or even other augmented information. To do so, the smartphone identifies the POIs in the scene, which may include POIs that are not visible in the scene (e.g., the smartphone detects their location and presence via locationing information), and computes a hierarchical cluster of the identified POIs based on the three-dimensional locations of the identified POIs. The smartphone also subdivides the display screen into multiple “tiles.” In this example, the tiles are not visible to the user, but instead represent logical divisions of all or a portion of the display screen area, for example by subdividing the display screen area into four quadrants. In this example, the tiles are used to manage the amount of augmented reality information that may be displayed on the screen.

In this example, the hierarchical cluster is represented by a tree having a root node and one or more nodes descended from the root node. The smartphone then traverses the hierarchical cluster beginning at the root node and projects information from the traversed nodes onto one or more of the tiles until a maximum number of nodes for each tile has been reached. The information from the traversed nodes, in this example, are displayed on the display screen as labels, and the smartphone optimizes the placement of each of the labels using image-based saliency to avoid occluding important parts of the scene, such as buildings or other POIs, and to avoid occluding other labels or nodes.

However, since the smartphone provides a display of the scene in real-time (or near-real-time) to the user, the information in the scene may change as the user moves or changes the orientation of the camera. When this happens, the smartphone updates the traversal of the hierarchical cluster and may display additional, different, or fewer labels based on the traversal.

In addition, this illustrative example allows the user to interact with one or more labels to expand the node and to explore more deeply into the hierarchical cluster. When a user selects a node to be explored, the smartphone traverses one or more child nodes of the selected node and generates and displays labels associated with those child nodes of the expanded node. Again, the labels are arranged on the screen using image-based saliency. In this case, because additional labels have been displayed on the screen, and they may occlude aspects of the scene or other labels. When the smartphone reconfigures the layout of the labels and will move existing labels, or may collapse other labels into a node to reduce the amount of augmented information visible on the screen, while presenting the labels associated with the selected node. Thus, this illustrative example provides augmented information to a user but addresses problems with occluding important aspects of the scene or other labels, and also provides a dynamic, interactive augmented virtual reality that updates as the view into a scene changes or based on user interaction with the augmented information.

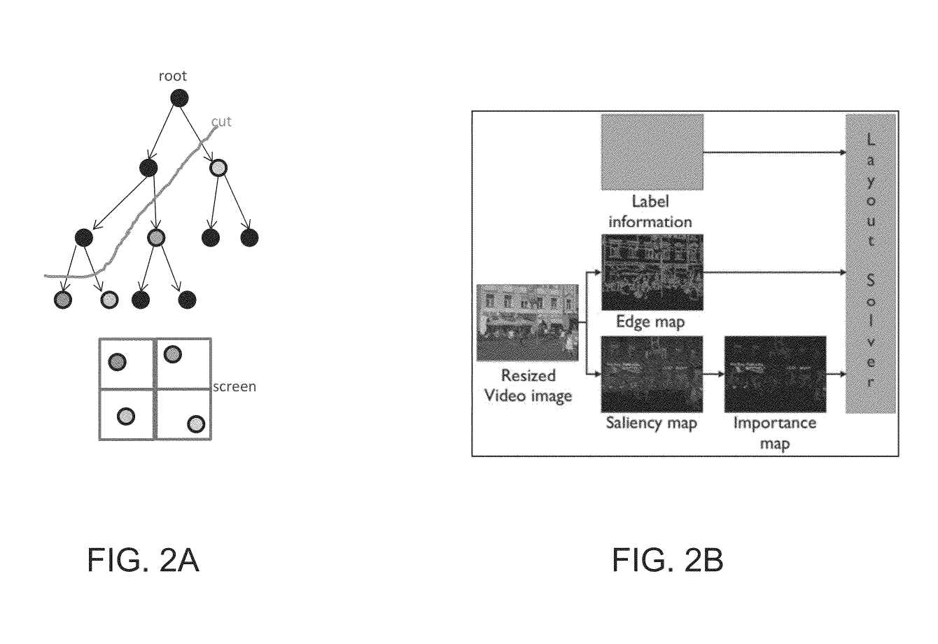

FIGS. 2A and 2B show how clustering information may be used as part of screen space management of a particular augmented reality view. As shown by FIG. 2A, in some examples, a screen may be subdivided into tiles. The tiles may allow the system to reduce on-screen clutter of AR nodes by limiting the number of nodes per tile, rather than a number of nodes to be displayed on the screen in general.

In this example, the system traverses a cluster tree from the root of the tree and project nodes or POIs to the screen. As the system traverses the tree, it projects the nodes onto the screen and associates the node with one of the tiles. In this example, the system traverses the tree according to a priority, such as based on a relative location to the AR viewpoint, a user preference, or other factor, such as sponsored advertising, and selects POIs from the cluster to display. In some examples, the system may displays all of the POIs for a scene. For example, there may only be two or three POIs in the scene. In some examples, however, a significant number of POIs may be available. In one example, the system projects POIs or nodes to the screen as it traverses the tree and upon reaching a threshold number of projected POIs or nodes, the system stops traversing the tree. In some cases, the system may traverse a tree and project POIs associated with a common parent node and if the system exceeds a threshold number of POIs, the system instead display the parent node and not the POI child nodes of the parent. A user may subsequently select the displayed parent node to expand it and view the child POI nodes. After selecting nodes for display, the system must determine where to display the labels.

Referring to FIG. 2B, FIG. 2B shows one example of optimizing label placement using image-based saliency. According to this example, as part of selecting placements for labels, a resized video image related to the output display for a system is identified. A saliency map is generated and used to derive features of the image or view. An edge map is also generated and is used to identify edge information for the view. The label information associated with the POIs nodes is also identified. The system then employs a means for displaying labels, such as a layout solver, to optimize the quantity and position of the label information for the selected POIs to maximize the edge information and important features for the scene represented by the resized video image.

As an AR view changes, the system traverses the tree according to the new AR view, regenerates the edge and view details, and the adjusts the placement of the POI detail information. Further, the system allows for interactive control by the user. For example, a user may interact with displayed labels presented in the augmented reality view to “open” or “unfold” a node. For example, a label associated with a POI may be displayed and the user may select the label using a user-manipulatable input device, e.g., a mouse or touch screen, or may execute a gesture in space for detection by a camera-based gesture detection system. Selection of the label may cause the system to display additional information within the label, such as user-generated content (e.g., reviews), information about wait times, etc. In some examples, selection of a label associated with a node may cause labels associated with child nodes of the node to be displayed. The system again employs the layout solver to adjust the displayed AR nodes based on the increased label information from the selected node. Thus, selecting a node may open or unfold the node and may cause other AR nodes to shifted away from their associated POI, be compressed such as being reduced in size or replaced by an icon, or removed from the view. If the selected node is closed or refolded, the system again employs the layout solver to adjust the displayed AR nodes based on the changes.

In certain embodiments, the layout solver may update the layout periodically. This may involve an update that appears to be in real time or near-real-time for a user. Such updates may occur periodically, such as every second or every five seconds, or may occur based on events such as changes in location or viewpoint. In some examples, the system may update the AR view after a threshold number of change in the view or label information occurs. For example, the system may only employ the layout optimizer when edge or other view details within the scene change by a sufficient amount. In some examples, label placement may be impacted by dynamic factors such as lighting. In some examples, the layout optimizer may be executed to provide real-time, such as at a rate of at least 24 or 30 times per second, or near-real time updates, such as at a rate of between 1 to 24 times per second. Further, in some example, as a view changes, the system may provide a weight to maintaining a node in a position relative to the background so that the node and associated metadata move with the background as a camera or sensor moves across a scene.

These illustrative examples are mentioned not to limit or define the scope of this disclosure, but rather to provide examples to aid understanding thereof. Still further examples are provided in the detailed description below.

A POI as used herein may refer to a physical location. For the purposes of an augmented reality view, the augmented reality may be considered to display information or metadata from a POI search related to the position of a user or the view of a user.

POI information and metadata, which may also be referred to as augmented reality information, refers to characteristics which describe individual POIs, and which may differentiate individual POIs from each other. For example, augmented reality information for a particular POI may include an address, phone number, opening times, food/drinks served, type of food, prices, user reviews, physical descriptions, and so on.

An augmented reality node (or “AR node”) refers to a point or area in an augmented reality display which identifies a POI, and which provides a base for the presentation of metadata associated with the POI, and for the addition of more information to an augmented reality view if an AR node is selected. In some examples, an AR node may thus be considered part of a browser which enables a user to navigate various levels of detail for a particular POI. An AR node may be unfolded, opened, or expanded to provide additional information in the augmented reality view, or closed or collapsed to reduce the amount of information in the AR view. In some examples, an AR node may correspond to a node in a hierarchical cluster tree, or may be a visual manifestation of such a node.

A label or annotation refers to POI metadata or augmented reality information that is displayed on a device output along with an AR node. This may include address and title information, or any information associated with a particular POI. In certain embodiments, a user or the system may select default label information, such as the name of a business, a person, or location title associated with a POI. When a user unfolds or opens an AR node, additional information may be displayed as part of the label.

An augmented reality viewpoint refers to the perspective of the sensor that creates the background view which is displayed with the augmented reality information to create the augmented reality view. The augmented reality viewpoint is thus local to the POIs, even if the display used to show a view to a user is remote.

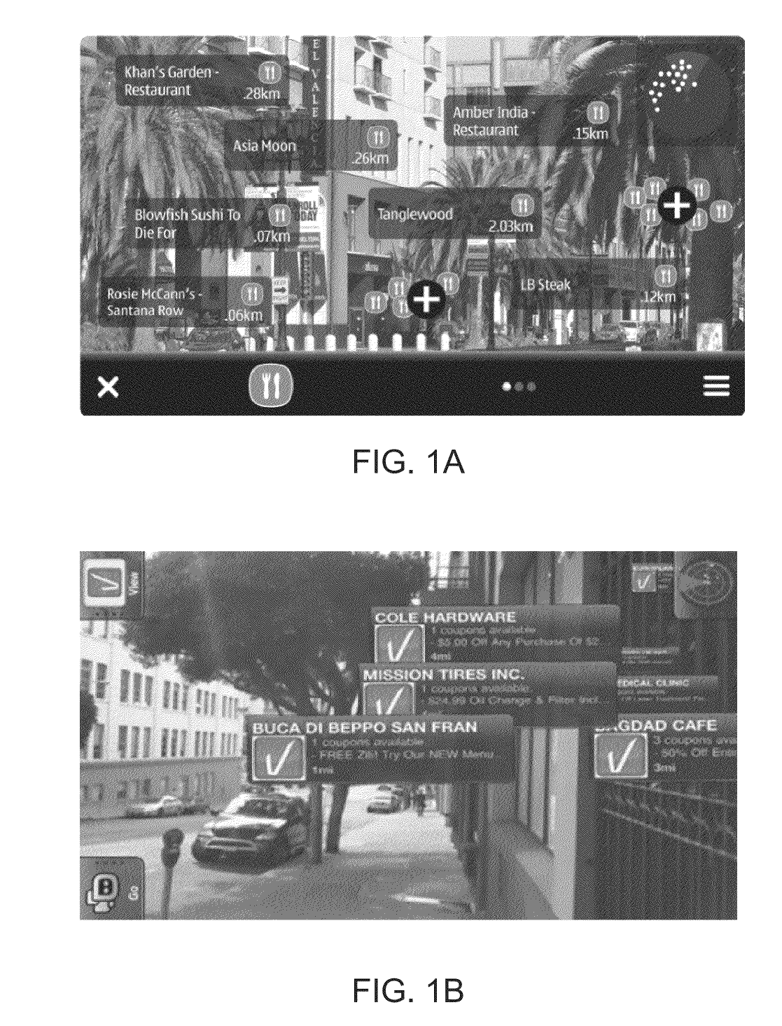

Referring now to FIGS. 1A and 1B, FIGS. 1A and 1B show examples of augmented reality views. They shows two views which are annotated with augmented reality information for a number of different POIs associated with the real world view represented by the background. As can be seen, the display illustrated in FIG. 1A includes a number of labels, some including descriptive text and others only including icons, which tend to obscure a substantial portion of the scene itself and result in a cluttered display that may be difficult to interpret. FIG. 1B suffers from a related problem in which some labels occlude other labels. In the example in FIG. 1B, a contributing factor may be the perspective of the AR viewpoint, which extends along street and provides very little real-world lateral separation between individual POIs, i.e., all of the POIs are located on the same side of the block and from the viewer's perspective are each behind the next nearest POI. Thus, when presenting the labels, this example simply arranges the labels in a manner similar to the arrangement of the real-world POIs, i.e., one behind the other. Such a display may not present information that is readily usable to a viewer or that makes navigation in the real world difficult to accomplish.

To improve the presentation of labels for view management of the augmented reality displays illustrated by the examples of FIGS. 1A and 1B, certain examples may implement precomputation for clusters of POIs. For example, a region of interest, such as a neighborhood or a city block, may be analyzed to identify POIs. Such information may be obtained from location-based Internet searches, a data store of local POIs provided by a service provider, or any other suitable data store having information about POIs.

In this example, the precomputation analyzes the real-world locations of the POIs to create a hierarchical cluster of POIs. For example, a node may be established corresponding to a particular city block, e.g., a city block bounded 4th street, 5th street, Cherry street, and Marshall street, or to a particular location, such as a mall or fair. POIs within the region are identified and may be grouped, for example by relative location or proximity to other POIs in the region. POIs may also be grouped according to different semantic categories, such as restaurants, entertainment, retail, professional, etc. These categories may then be further subdivided, e.g., Italian restaurants, Thai restaurants, retail clothing stores, movie theaters, dentist office, etc. These can be further subdivided according to reviews, etc. Thus, by arranging the categories in a desired hierarchy (e.g., location, restaurants, Italian, medium price point), child nodes may be added into the hierarchy. Thus, the hierarchy establishes clusters of POIs according to certain criteria, and these hierarchical clusters of POIs are thus precomputed in 3D world space.

In addition to the techniques discussed above, clustering may be accomplished using other methodologies as well. One example technique includes hierarchical k-means clustering. Various techniques may generate hierarchical clusters using one or more metrics, such as a weighted sum of: (1) the POI distance from the user or camera in 3D world space; (2) a semantic similarity or a percent of matching tags or metadata information for given POIs; (3) a geometry of a view or scene presented as part of an augmented reality view, including building models and outlines; (4) a travel time to a particular POI, especially where geography dictates that this time would create a different set of information than distance information (e.g., walls, roadblocks, and rivers creating barriers that must be moved around) (5) addresses; and (6) user- or system-selected weights. In various embodiments, any combination of these and other weights may be used as clustering metrics to compute hierarchical clusters of POIs.

While potentially computationally-intensive, clustering may be performed in real-time or near-real-time. For example, a user may enter an area that does not have precomputed hierarchical clustering information. In one example, the user's AR device may access location-based information via a network connection, such as from a location-based internet search, obtain POIs for an area centered on the user (e.g., a circular area with a radius of 0.5 km from the user's location), and determine a hierarchical clustering that may be used to provide AR labels. In one example, a user may change a preference associated with a clustering to cause the clustering to be re-executed based on the changed preference.

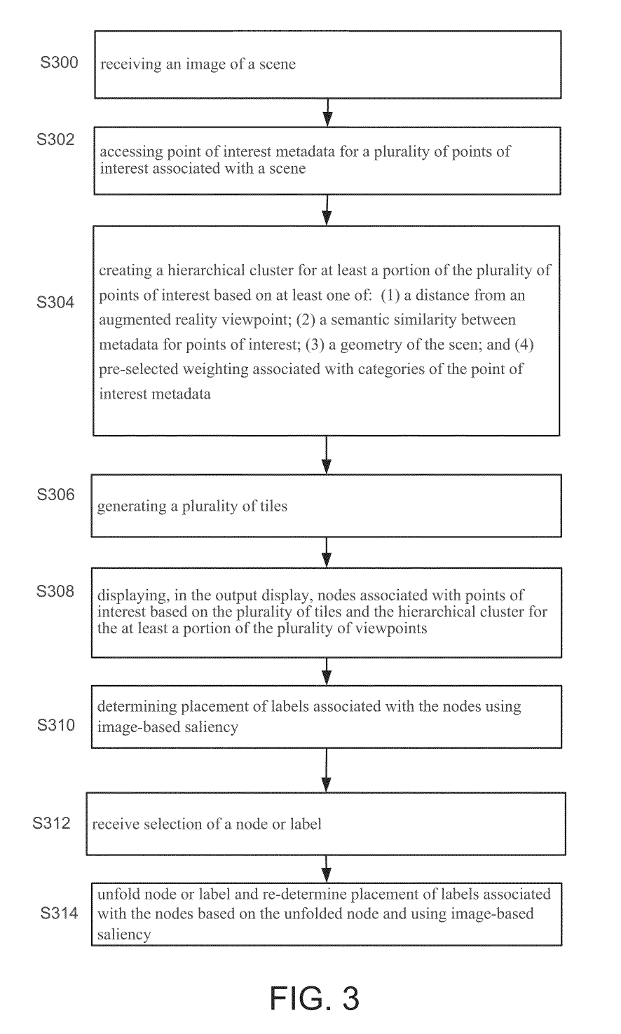

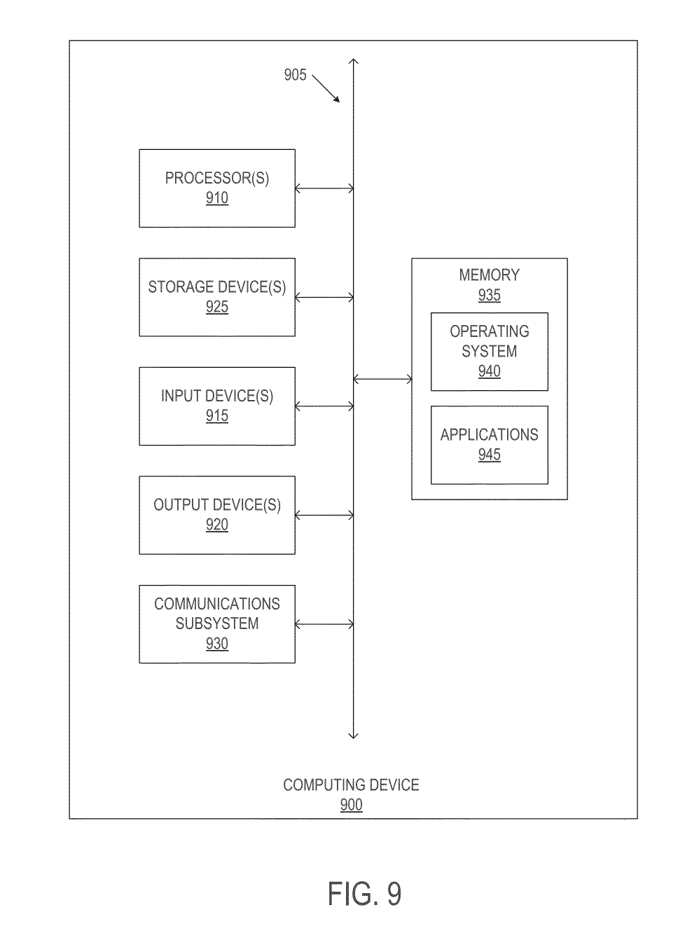

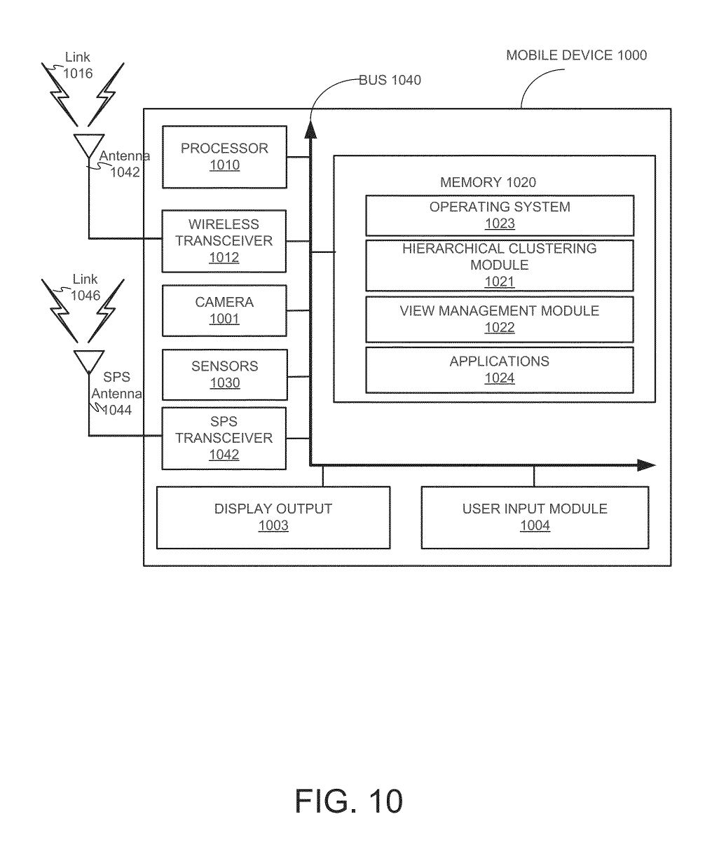

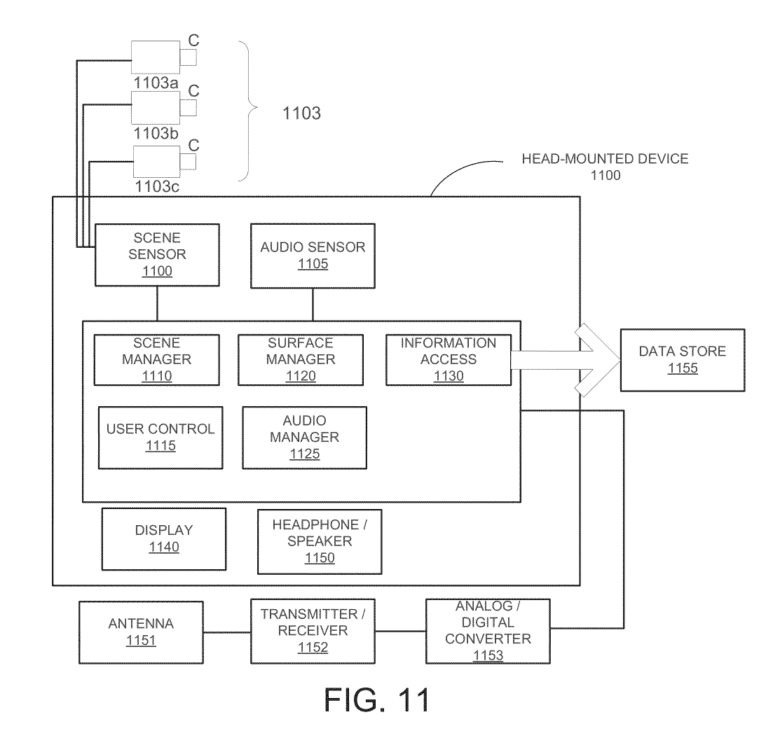

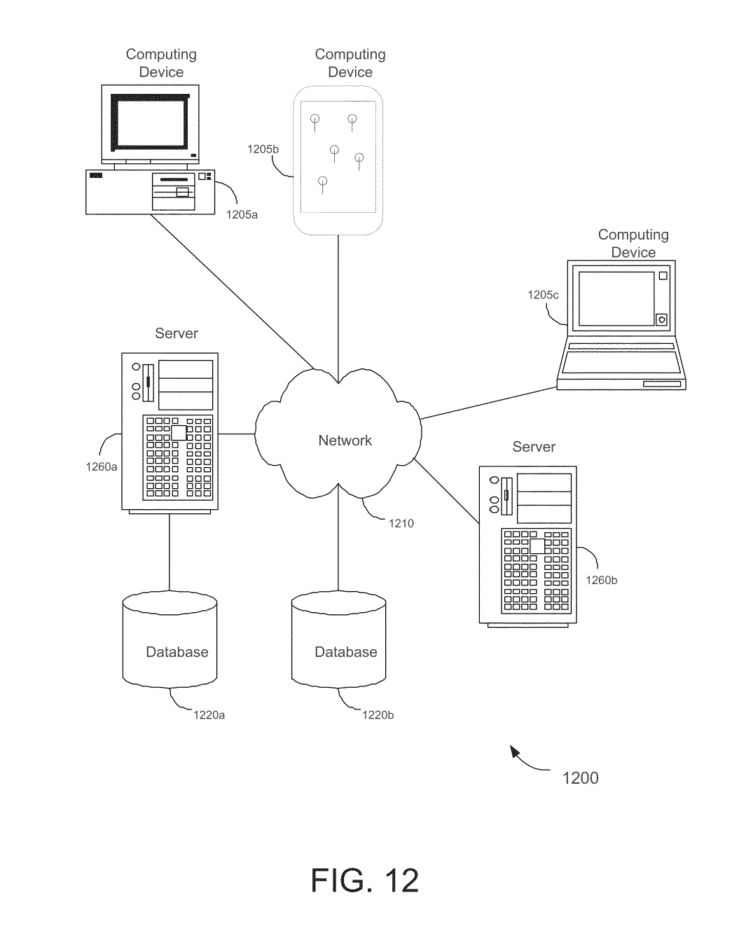

Referring now to FIG. 3, FIG. 3 shows an example method of hierarchical clustering for view management with augmented reality. The method of FIG. 3 will be described with respect to the device 1000 shown in FIG. 10; however, the method may be executed by any suitable device or system, including the devices shown in FIGS. 9 and 11 or the system shown in FIG. 12.

The method 300 begins at block S300. At block S300, an image of a scene is received by the device 1000. In this example, the device 1000 captures video of the scene using its camera 301. However, in some examples, the device may receive images or video of a scene from a remote device over a network connection or from an external camera in communication with the device 1000.

At block S302, the system accesses POI metadata for a plurality of POIs associated with the scene. For example, the system may access one or more data stores and retrieve data records associated with a plurality of POIs. The system may employ a means for accessing POI metadata, such as a database query or file system, As described above, the POI information may be stored locally within the device, or may be accessed from one or more data stores over a network, such as network 1210 shown in FIG. 12 or the Internet. The system may access POI metadata based on a selected location, such as GPS coordinates associated with a location of an AR viewpoint, or based on user input.

In one example, the mobile device 1000 comprises a GPS receiver and obtains GPS location information from the GPS receiver and associates the GPS location information with the capture images or video. Such GPS information may include a latitude and longitude as well as a directional heading. In some examples, other sensors or components may be employed to obtain location information, such as inertial sensors or WiFi.

At block S304, the device 1000 generates a hierarchical cluster for at least a portion of the plurality of POIs. In this embodiment, the system generates the hierarchical cluster using hierarchical k-means clustering based on at least one of: (1) a distance from an augmented reality viewpoint; (2) a semantic similarity between metadata for POIs; (3) a geometry of the scene; and (4) pre-selected weighting associated with categories of the POI metadata. Some example systems comprise a means for generating a hierarchical cluster using such a technique. In some embodiments, the device 1000 may generate the hierarchical cluster based on other or additional information, such as a driving distance to the POI or the address of the POI or the AR viewpoint.

In some examples, the device 1000 may receive a hierarchical cluster from a remote computing device or server using a network, such as network 1210 or the Internet. In one example, the device 1000 may transmit location and heading information or one or more captured images to a remote computing device, which generates a hierarchical cluster for one or more of the POIs in the scene and transmits the hierarchical cluster to the device 1000.

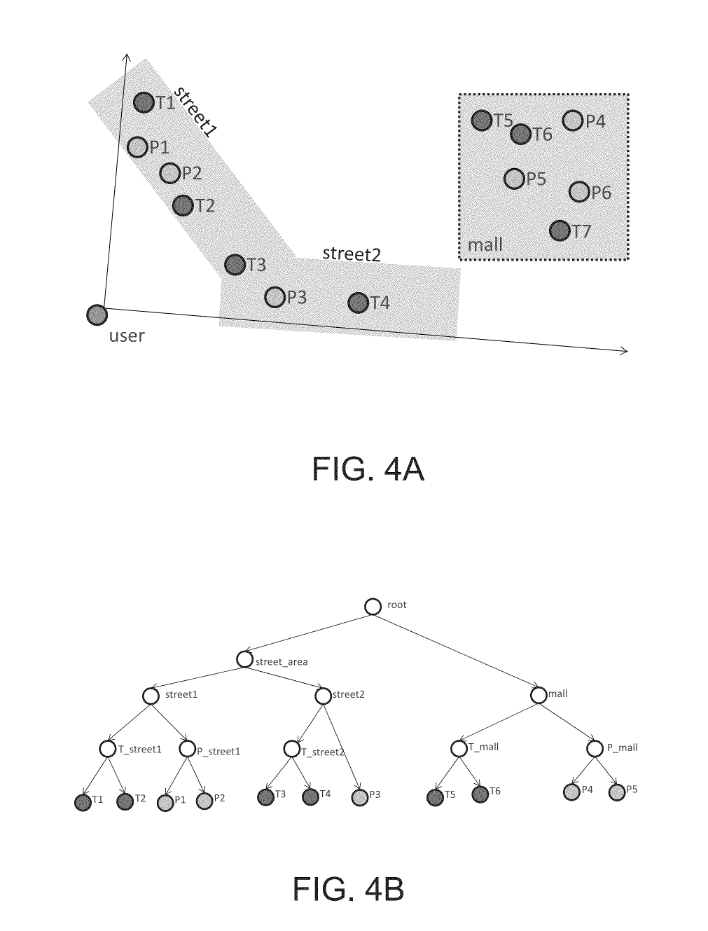

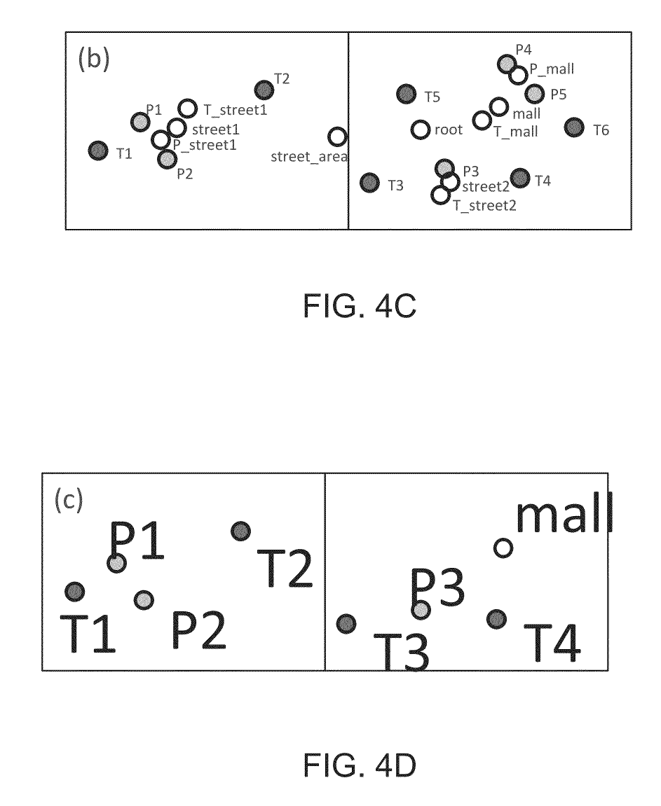

For example, FIG. 4A illustrates aspects of an example environment that may be augmented as part of an augmented reality system according to certain embodiments. FIG. 4A shows a top down map, with a user view that includes a plurality of Pizza (P) and Thai (T) restaurants. As shown, the user view includes POI restaurants on two streets and in a mall area that is on the opposite side of the streets from the user.

FIG. 4B illustrates aspects of an example cluster tree according to one embodiment. The cluster tree may be precomputed from map information combined with any other information related to POIs in the environment. The information may be gathered from a database that includes information for an entire geographic area, with clusters precomputed for given user positions within the geographic area, and further associated with potential views that may exist for a user position. A cluster tree will therefore only include information structures for a portion of the POIs within a geographic area.

As shown in FIG. 4B, the cluster tree includes a root, which is simply a starting point for POIs in the view. In certain embodiments, a root may also be a node presented to a user to enable collapsing of all the augmented reality information into a small space to maintain user interface consistency while maximizing the background view with almost no interference from the augmented reality information. Logical geographic groupings may then be used as second tier node structures within the cluster trees. While these are shown as associated with particular streets and mall areas, any similar such groupings may be provided. Examples include street blocks, building levels for multi-story buildings, or any other such logical grouping. As further shown by FIG. 4B, a third level grouping under the street area node includes specific streets, a fourth level grouping includes restaurant type groupings by street, and a fifth level grouping includes the specific restaurants. Similarly, a third level grouping under the “mall” node includes a grouping of mall restaurants by type, and a fourth level mall grouping includes specific restaurants. In alternative embodiments, any number of node levels may exist under different groupings. Further, in certain embodiments, a specific restaurant or other POI may be included in the cluster tree multiple times. For example, in an alternative embodiment of FIG. 4B, if a hypothetical pizza restaurant specializing in Thai7 flavored toppings existed within the mall area of FIG. 4A, that Thai themed pizza restaurant could be included under both the T_mall and the P_mall nodes.

At block S306, the device 1000 divides an output display space into a plurality of tiles. For example, the device 1000 may divide the output display space into four tiles corresponding to four quadrants of the display space. In some examples, a greater or lesser number of tiles may be employed. Further, tiles of different sizes and shapes may be used in some examples. For example, the device 1000 may divide the output display space into three tiles with one tile representing the left half of the display space, one tile representing the upper right quadrant of the display space, and one tile representing the lower right quadrant of the display space. In some examples, the device 1000 generates tiles based on detected features in the scene. For example, referring to FIG. 1B, the device 1000 may subdivide the right half of the display space into one tile and the left half of the display space into a plurality of tiles. Such an arrangement may limit the number of labels displayable within the right half of the screen, despite numerous POIs being represented on the right half of the screen.

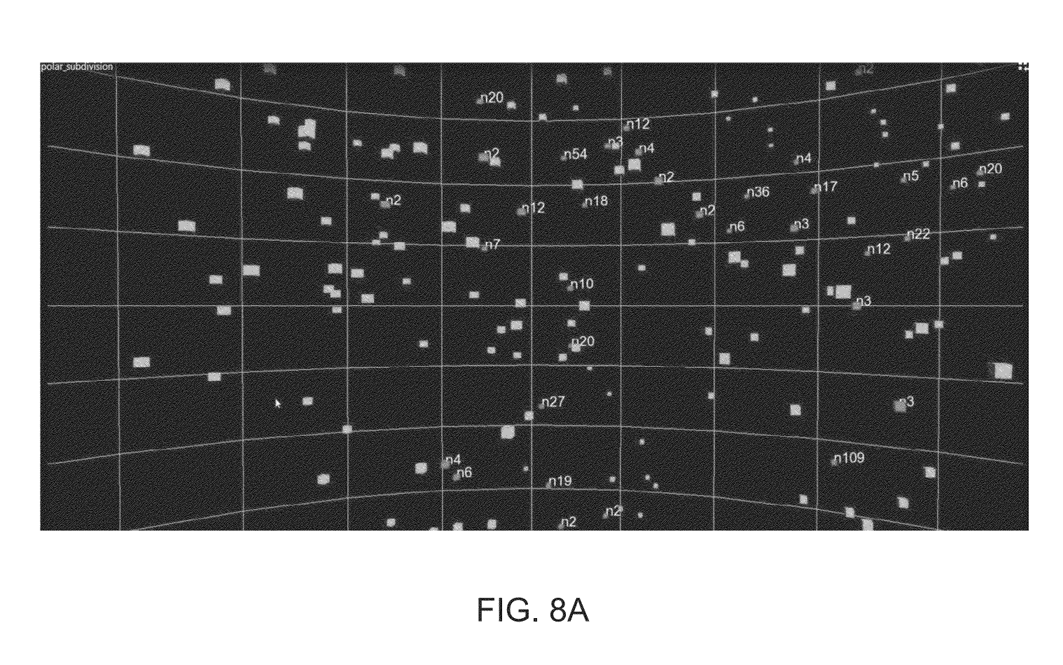

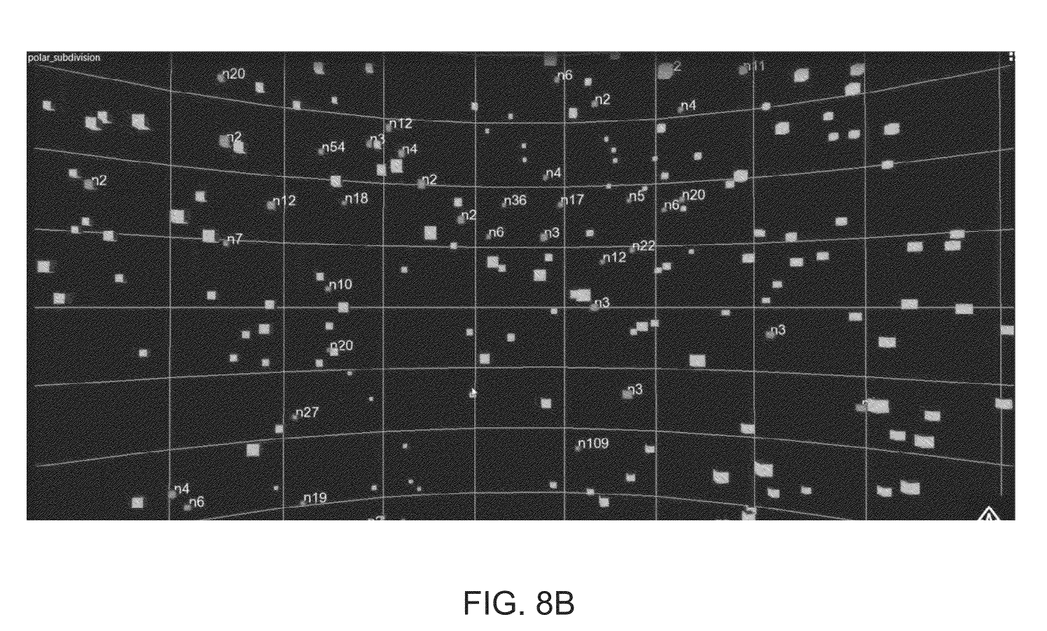

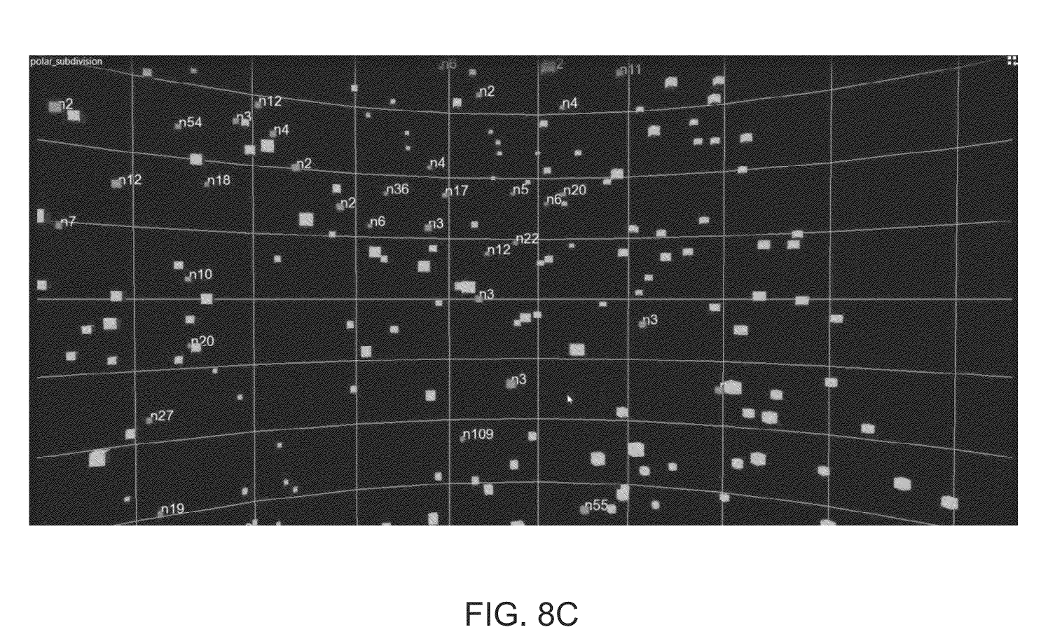

As is discussed in greater detail below with respect to FIGS. 8A-C, in some examples, the device 1000 divides an environment or real-world space into a plurality of tiles. In one example, the device uses a polar coordinate system having an origin at the camera to establish a coordinate system and to assign coordinates to the POIs or other features in the environment. The device also divides the coordinate space into a plurality of two-dimensional spaces. For example, in one aspect the device divides the environment space into equally-sized tiles with an apparent distance of approximately 100 meters from the camera. In some examples, a system may include a means for establishing a plurality of subdivisions using the techniques described above.

After the device 1000 generates a hierarchical cluster for at least a portion of the plurality of POIs, the method proceeds to block S308.

At block S308, the device 1000 displays, in the output display, AR nodes associated with POIs based on the plurality of tiles and the hierarchical cluster for the at least a portion of the plurality of viewpoints. The device 1000 traverses the hierarchical cluster tree and assigns AR nodes associated with nodes in the hierarchical cluster to tiles based on a location of an associated POI or cluster of POIs in the scene. As the devices traverses the hierarchical cluster tree and displays AR nodes in the tiles, the number of AR nodes displayed within a tile may reach a threshold number of AR nodes. In some examples, the device 1000 continues to traverse the hierarchical cluster tree, but skips nodes in the tree that would cause a display of an AR node in a tile that is “full.” Thus, the device 1000 continues to traverse the hierarchical cluster tree and display AR nodes in other tiles.

For example, FIGS. 4C and 4D illustrate a display. FIG. 4C illustrates a display including all possible nodes as part of an augmented reality view according to certain examples. FIG. 4C thus essentially represents an outline of a display output for a device having two tiles. Two tiles are used here for simplicity, however, in some examples, a device output display may have 5,000 tiles in a 100×50 grid. In other embodiments, a device may have a 900×900 grid, a 10×12 grid, or any other grid compatible with a device's output display. The nodes shown in the output display of FIG. 4C include all of the nodes for POIs from the user view of FIG. 4A, discussed above.

FIG. 4D illustrates an example display including selected nodes as part of an augmented reality view. In the example of FIG. 4D, each tile may have a limit of four labels per tile. This limit may be user-selected, or may be derived from average label size associated with POI nodes and/or a limit on the amount of augmented reality label information area that may obscure the background view. In some examples, this may be a limit on a percentage of the area that may be obscured rather than a label limit. In other examples, any such consideration, metric, or threshold may be used to determine a label limit. In certain embodiments, there may be a threshold for each base tile and an additional threshold for groupings of tiles. For example, the system may set a maximum of four labels per tile and a maximum of seven labels for two adjacent tiles. Such means for selecting a plurality of POIs from the hierarchical cluster tree described above, as well as those discussed below, may be incorporated into one or more example systems according to this disclosure.

In the example of FIG. 4D, the nodes are displayed by proximity and distance. Because the “mall” environment and the associated POIs are further from the user as shown in FIG. 4A, when the cluster tree is traversed to identify the initial nodes for display on the output screen, the mall nodes are more clustered and are displayed as a single collapsed AR node. The closer POIs are displayed with the POI tags instead of a higher level node from the cluster tree. FIG. 4D thus displays seven restaurant AR nodes and one AR node for the mall. Eight total AR nodes are shown because there are two tiles with a limit of four nodes per tile in this example. If, for example, the user view included six streets instead of two as shown, the output display of FIG. 4D may instead show a single restaurant AR node, six street AR nodes, and the mall AR node.

In some examples, when a number of AR nodes in a tile reaches a threshold, such as a maximum number of nodes for a tile, the device may attempt to collapse the nodes into a single node. For example, if a tile includes a plurality of AR nodes that are all associated with nodes in the hierarchical cluster tree that are child nodes of the same parent node, the device may collapse the AR nodes associated with the child nodes and replace those AR nodes with a single AR node associated with parent node in the hierarchical cluster tree of the child nodes. Thus, in some examples, the device 1000 may attempt to reduce a number of AR nodes displayed within a single tile.

In some examples, the device 1000 may only collapse AR nodes under certain conditions. In one example, the device 1000 may only collapse AR nodes that are associated with POIs more than 0.1 kilometers from the AR viewpoint, or AR nodes associated with POIs that are not visible within the scene, such as indoor stores within a mall or stores that are located on a far side of a building visible in the scene.

In some examples, once all tiles are full, or the hierarchical cluster tree has been fully traversed, the method may proceed to block S310. In some examples, the method proceeds to block S310 once any of the tiles has reached a threshold number of AR nodes.

At block S310 the device 1000 determines placement of labels associated with the nodes using image-based saliency and displays the labels according to the determined placement. In some examples, additional information may be employed to determine the placement of the labels. For example, in one aspect, the device 1000 may employ a means for displaying labels that determines edge information for the scene and may determine placement of the labels based on image-based salience and the edge information.

At block S312, the system receives a selection of an AR node or label. For example, a user may use a mouse or other input device to move a cursor to select an AR node, a user may touch a touch-sensitive input device at a location corresponding to an AR node, or may perform a gesture for a camera-based gesture detection system to select an AR node, such as by pointing in real-world space at an apparent location of the AR node. These and other means for receiving a selection of a node may be incorporated into one or more example systems.

At block S314, the device 1000 unfolds the selected AR node or label in response to the selection. In this example, unfolding the AR node involves obtaining additional information associated with the AR node, displaying at least a portion of the additional information, and adjusting the placement of other augmented information on the display based on the display of the additional information. In some examples, unfolding the AR node involves additional or fewer steps. For example, additional information may already be available such that no additional information needs to be obtained. In some examples, the adjusting the placement of other augmented information, including AR nodes or labels, may include animation of the rearranging or may involve collapsing or removing other augmented information.

In this example, the device 1000 identifies information associated with the AR node, such as information from an associated or corresponding node in the hierarchical cluster tree. In some examples, the information may include additional descriptive information about a POI associated with the AR node or one or more child nodes of a node associated with the AR node. For example, the additional information may include user reviews or ratings of a POI, information about hours of operation, an estimated travel time, an address, or any other information about or related to the POI. In some examples, the additional information may include one or more child nodes of a node in the hierarchical cluster tree associated with the AR node.

The device 1000 also displays at least a portion of the additional information associated with the AR node. For example, if the additional information includes additional descriptive information for a label associated with the AR node, the device 1000 may increase the size of the label to accommodate the additional information, or may incorporate user interface controls into the label, such as a scroll bar, to provide access to the additional information. In some examples, unfolding the AR nodes results in additional AR nodes being displayed. For example, an AR node may be associated with a node in the hierarchical cluster tree that has one or more child nodes. Unfolding the AR node may include displaying AR nodes associated with the one or more child nodes, including icons or labels associated with the one or more child nodes. In some examples, displaying the additional information may include ceasing display of the selected AR node, or it may cause a change in appearance of the selected AR node. These and other means for updating the displaying of labels based on opening the selected node, such as those described below, may be employed by one or more systems.

When the device 1000 displays additional information, it may adjust the placement of other augmented information in the display.

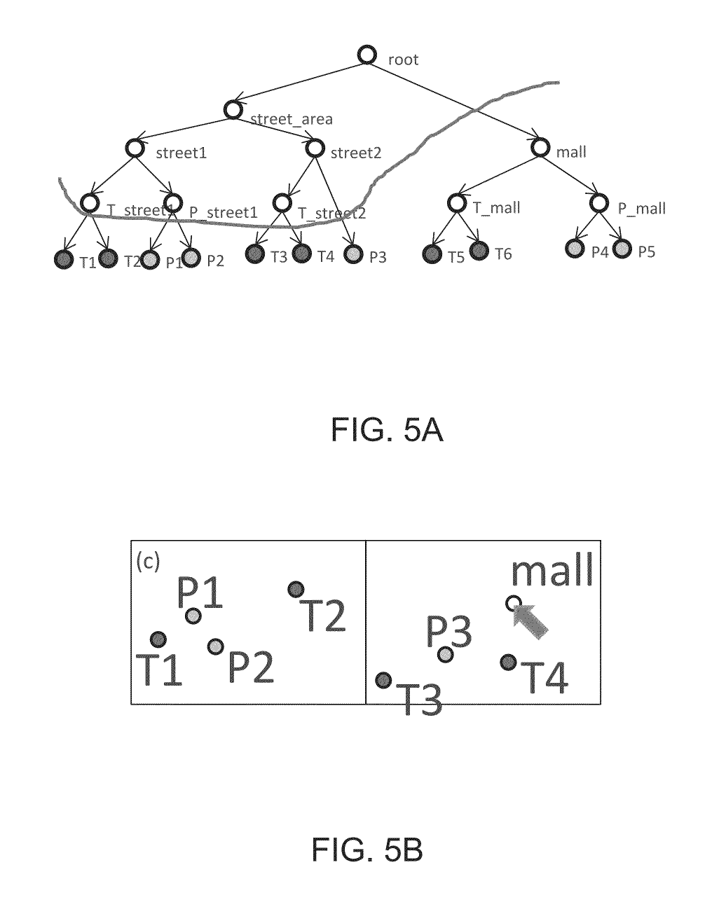

Referring now to FIGS. 5A and 5B, FIG. 5A shows a hierarchical cluster tree with a line to indicate the cut-off point, referred to as a “cut line,” at which the device 1000 has traversed the tree, and FIG. 5B shows a simulated view of the displayed augmented information in a display having two tiles. The nodes and associated labels directly below the cut line in FIG. 5A are the nodes that will be displayed in an output display for augmented reality. The nodes above the cut line are not shown, because the information from the parent nodes above the cut line are included as part of the information for the child nodes which are displayed. If the nodes below the cut line are collapsed, for example, if nodes T3 and T4 are collapsed, the line will adjust upward such that the T_street2 node will then be displayed, and its child nodes will no longer be displayed. In this example, in the “mall” side of the tree, only the “mall” node beneath the cut line is displayed on the device output.

FIG. 5B then shows the same output display, but the user makes a selection to expand the “mall” node. This may be done by touching the node or label information associated with the “mall” node on the display. In other embodiments, an ordered list of nodes may be navigated using arrows, a scroll input, voice commands, gesture commands, or any other such user interface selection.

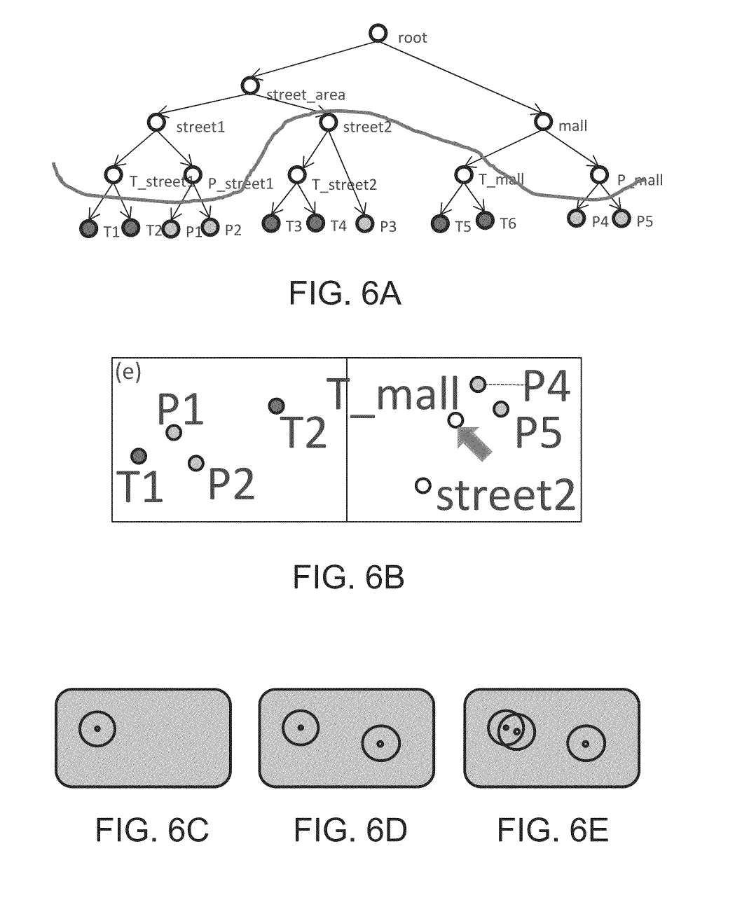

FIGS. 5A and 5B illustrate the change to the cut line in the hierarchical cluster tree and the change in the output display after the selection to expand the “mall” node, as shown in FIG. 5B. As the mall AR node is expanded, the device 1000 determines whether a maximum number of AR nodes in each tile will be exceeded. In this example, expanding the mall AR node causes additional AR nodes to be displayed and exceed the maximum number of AR nodes per tile, which in this example is four. Thus, the device 1000 determines that a node must be collapsed. In this example, the right tile included four AR nodes before the mall node was expanded. When the mall node was expanded, the system also expanded the P_mall node, which would add three additional AR nodes to the display. Thus, three of the originally-displayed AR nodes must be removed; however, because the mall node is being opened or unfolded, it will be removed, leaving two additional AR nodes to be removed. To remove two nodes, while expanding the mall node, the device 1000 identifies the nodes in the tile, other than the selected node, and determines which can be collapsed. In this case, the T3 and T4 AR nodes can be collapsed into the T_street2 AR node. However, collapsing those two AR nodes into one AR node only eliminates one AR node from the tile, so the device 1000 further determines that the T_street2 and P3 AR node can be collapsed into the street2 AR node. Thus, the system collapses all of the T3, T4, and P3 AR nodes into the street2 AR node, which moves the cut line above the street2 node in the hierarchical cluster tree, and moves the cut line below the mall node in the hierarchical cluster tree as may be seen in FIG. 6A. The system then displays the AR nodes resulting from unfolding the mall AR node and the street2 node that resulted from the collapsing of the T3, T4, and P3 AR nodes.

In some examples, the determination of which nodes to collapse may be based on various user preferences and system determinations. For example, the system may determine to display fewer than the maximum number of allowable labels. In other embodiments, the system may make other adjustments to the display of certain nodes as part of a single selection. In the example of FIG. 6A, the system not only displays the nodes directly below the selected mall node, but also further opens a second level “P_mall” node below the “mall” node. This may be done because of a user-selected preference for Pizza POIs over Thai POIs, and may also be based on the need to collapse one of the street area nodes. In alternative embodiments, the system could display the T_mall and P_mall nodes while collapsing T1 and T2 to T_street1. In the embodiment of FIG. 6B, however, T3, T4, and P3 are collapsed into the street2 node, and the mall node is expanded into the T_mall, P4, and P5 nodes. The user may then make a further selection to request additional expansion of the mall node by selecting the T_mall node as shown by FIG. 6B.

Additionally, as is shown by FIG. 6B, room is made in the left side tile by moving the “street2” node to the right tile, even though T1 and T2 which collapse into street2 were in the left tile. In various embodiments, any such adjustment of nodes and labels may be done in order to optimize system determinations. In certain embodiments, the display of a node and the associated label within a tile may be based on an optimized determination that balances the proximity of the node to the actual location within the view and the display optimization. In further embodiments, if a node is shifted away from the actual location or the tile where the POI may be seen in the background, an arrow, line, or other indication may be used to associate the node and label with the placement of the corresponding POI in the background.

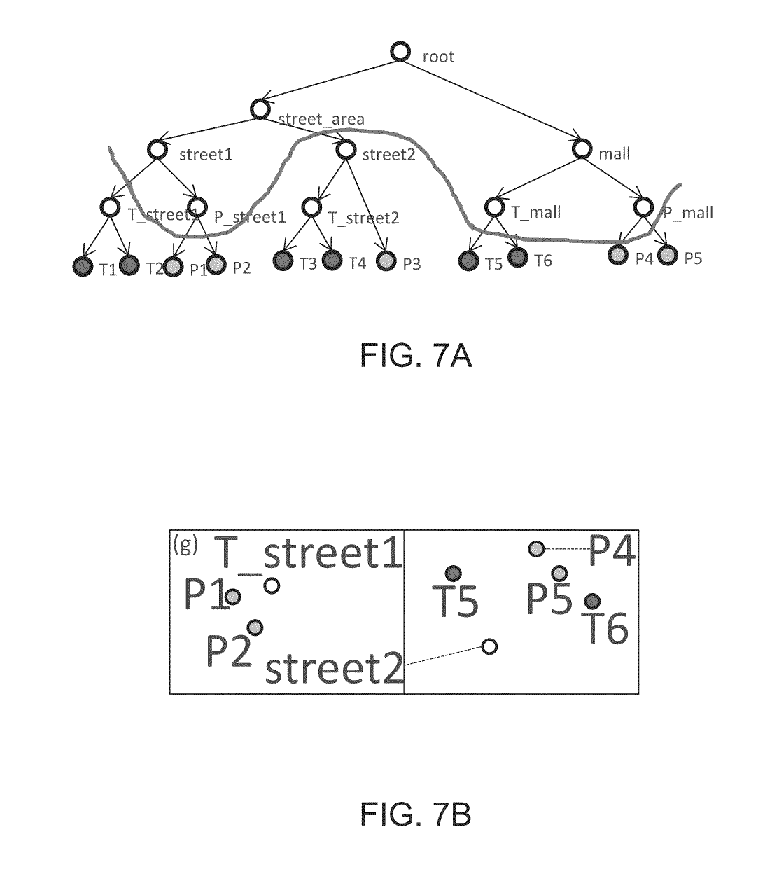

Referring to FIG. 7A, FIG. 7A shows the cluster tree with the cut line after the T_mall AR node is expanded based on a user selection of the T_mall AR node. As shown in FIG. 7B, the T_mall node is expanded to T5 and T6 and the T1 and T2 nodes are collapsed into the T_street1 node. In this example, while the maximum number of AR nodes or labels per tile remains set to four, the device 1000 retains the previously unfolded P_mall node, resulting in five AR nodes in the right tile. Such a result may be based on a user preference for the Pizza restaurant information, or on a predetermined setting to leave recently unfolded nodes for a period of time to eliminate desired information from being too quickly removed. The device 1000 instead compensates for the additional node in the right tile by collapsing a node in the left tile resulting in eight total AR nodes being displayed across both tiles. In this example, the device 1000 has collapsed the T1 and T2 AR nodes into the T_street1 AR node. Thus, the device 1000 has adjusted the placement of augmented information based on an unfolding or opening of an AR node. These and other means for updating the displaying of labels based on closing a node may be employed be one or more example systems.

After the device 1000 has unfolded the selected node, the method has completed. However, in some examples, the system may iteratively execute portions of the method of FIG. 3. For example, in one aspect, after determining placement of labels at block S314, the device 1000 may detect a change in AR viewpoint or receive a selection of an AR node or label and return to S308. In some embodiments, as discussed above, the device 1000 may return to S306 to determine a new tile configuration for the display space.

While the above description for FIGS. 6A through 6B include a simplified illustrated embodiment for restaurants of two types, any number of cluster levels may be included in various embodiments. The determination of node selection for display may be based on any number of factors for very complex nodes. Such factors may include user search terms, a user preference history, system determinations related to POI similarity, system advertising inputs, and any other such information that may be used. Additionally, while the specific POIs are shown as having a single node and POI, in certain embodiments a single business or structure associated with a POI may have multiple tiers of label information. For example, a single pizza restaurant may have a top tier node label with just the business name. If the top node is expanded, any other information such as hours, contact information, user reviews, and other such information may be included in a cluster tree. A single business associated with a single location may thus take up more than one node for the purposes of tile limits within a display. If a user selects the node for T1, for example, in FIG. 7A, the system may open additional labels with information for T1, while collapsing other nodes.

In still further embodiments, the display of nodes and labels based on saliency as described above may be combined with other inputs to create hybrid displays for augmented reality. For example, a system may have a user input for real-time adjustment of clutter that will collapse or expand nodes in the cluster tree without selection of a specific node.

In some examples described above, an output display space may be divided into multiple tiles. In some examples, however, a real-world environment itself may be divided into tiles that are fixed relative to coordinates in the real-world environment. For example, a device may capture a real-world environment by a camera and assign coordinates to POIs or other features in the environment. As described above with respect to FIG. 6, in one example, the device uses a polar coordinate system having an origin at the camera to establish a coordinate system and to assign coordinates to the POIs or other features in the environment. The device also divides the coordinate space into a plurality of two-dimensional or three-dimensional spaces. For example, in one aspect the device divides the coordinate space into equally-sized two-dimensional tiles with an apparent distance of approximately 100 meters from the camera. This type of view-dependent space subdivision may be determined during precalculation of the node tree. In alternative embodiments, the space subdivision may be user-selected, or may vary depending on characteristics of the physical environment to match the devices in use with the information available to present augmented reality information to a user in a certain environment. In some examples, one or more tiles may be dynamically generated based on identified POIs.

For example, in one aspect, the device dynamically divides the coordinate space into one or more tiles. In this aspect, the device initializes a coordinate space having no tiles, and after identifying a POI, generates a first tile surrounding the POI. The device may then identify a second POI. After identifying the second POI, the device may place the second POI in the first tile, or in some aspects, the device may generate a second tile for the second POI, which may or may not overlap with the first tile. The device may iteratively generate additional tiles as additional POIs are identified, or may assign one or more of the additional POIs to existing tiles. In some aspects, one or more of the dynamically generated tiles may comprise different shapes. For example, in some aspects, tiles may be polygons, such as rectangles or triangles. In other some aspects, tiles may be circular and may be centered on a respective POI with a radius based on a characteristic of one or more POIs, such as its distance from the device, a relative importance of the POI, or the number of POIs within the tile.

Referring now to FIGS. 6C-E, FIGS. 6C-E illustrates examples of dynamically generating tiles as a part of an augmented reality view according to certain examples. In FIG. 6C, a first POI is identified and a first circular tile is generated and centered on the first POI. The device then identifies a second POI and generates a second circular tile centered on the second POI. The device then identifies a third POI and generates a third circular tile centered on the third POI, even though the third POI is otherwise within the first tile. In this example, the third circular tile overlaps the first circular tile, though in some examples, the device may not generate a third tile, but instead may assign the third POI to the first tile. In some examples, a system may comprise a means for establishing a plurality of subdivisions using the techniques described above.

A hierarchical cluster tree will be generated in these examples as described throughout this written description. However, POIs will be associated with coordinates within the coordinate space and thus will be assigned to a tile in the coordinate space. In some examples, nodes will be collapsed or expanded according to predetermined threshold values associated with a maximum number of AR nodes or labels per tile, or per group of tiles. Thus, as described above, the display of AR nodes or labels will operate according to various aspects of this disclosure, however, the tiles will be fixed within the environment or coordinate space, rather than associated with tiles in the output display space. Further, as a user selects AR nodes to expand or collapse, the placement of AR nodes and labels within the environment will be adjusted, such as by moving or resizing labels or collapsing AR nodes into a parent AR node, as described above. Further, because the tiles are fixed within the coordinate space, as the AR viewpoint changes, the set of tiles and associated AR nodes and labels changes based on the AR viewpoint.

Referring now to FIGS. 8A-C, FIGS. 8A-C illustrate an example environment that has been divided into tiles. As can be seen in FIG. 8A, a plurality of tiles have been determined within the environment space and POIs represented by red cubes and associated labels are visible within the tiles. Further, AR nodes corresponding to collapsed nodes are also visible as green cubes. Thus, a user may select a collapsed node to unfold it, which may result in the placement of other augmented information being adjusted as described throughout this written description.

FIGS. 8A through 8C represent a camera panning to the right through the environment space. In this example, because the tiles and the nodes are fixed to coordinates within the environment space, both the visible AR information and the tiles shift to the left during a progression from FIGS. 8A to 8C. For example, in FIG. 8C, the leftmost node from FIG. 8B has shifted off the left side of the view. As may be seen from the progressive change in AR viewpoint illustrated by these figures, the tiles are fixed in the three dimensional space representation, and remain fixed relative to the nodes as the camera pans. This is in contrast to the embodiment described in, for example, FIGS. 4-7 where the tiles remain fixed relative to the output screen, and the relative position between the tiles and the nodes change as the AR viewpoint changes.

Referring now to FIG. 9, FIG. 9 shows one example of a computing device 900 that may be used for hierarchical clustering for view management in augmented reality. The computing device 900 includes one or more processors 910, one or more storage devices 920, one or more input devices 915, one or more output devices 920, a communications subsystem 930, and a memory 935, configured to store an operating system 940 and one or more application programs 945. In this example, the processor 910 may be used to implement any of the systems or methods for augmented reality as described herein. The computing device 900 may comprise a desktop or laptop computer, or may comprise a portable or handheld device, such as a tablet, a phablet, a smartphone, a wearable device such as a head-mounted goggles or a head-mounted display. For example FIG. 10 shows one implementation of a device 1000 according to certain embodiments.

Referring now to FIG. 10, device 1000 comprises a mobile device, such as a smartphone, that includes a processor 1010, a wireless transceiver 1012 and an associated antenna 1014, a camera 1001, one or more sensors 1030, an SPS transceiver 1042 and associated antenna 1044, a display output 1003, a user input module 1004, and one or more memories configured to store an operating system 1023, a hierarchical clustering module 1021, a view management module 1022, and one or more applications 1024. In this embodiment, the device is configured to capture images or video of a real-world environment, or scene, from the perspective of the camera, also referred to as an augmented reality (AR) viewpoint. The processor 1010 is configured to execute the hierarchical clustering module 1021 and the view management module 1022 to provide augmented information overlaid on the captured images from the camera to provide augmented images of the scene, such as in the form of an augmented video of the scene. For example, the camera 1001 may capture an image or video of an environment, hierarchical clustering module 1021 may include precomputed cluster trees, and may work in conjunction with view management module 1022 to identify POIs from the captured image or video to output augmented images or video on display output 1003 in accordance with the embodiments described herein. In this example, the mobile device 1000 may be connected to one or more display devices, such as a head mounted display.

In some examples, the mobile device 1000 includes a display device and may provide the augmented images or video to the display device. Further, in some examples, the mobile device 1000 may be configured to transmit the augmented images or video over a wireless link 1016, 1046 using the wireless transceiver 1012 or the SPS transceiver 1042. In one such example, the device may be configured to provide the augmented images or video to both the mobile device's display and to substantially simultaneously wirelessly transmit the augmented image to another device.

Referring now to FIG. 11, FIG. 11 shows one example of a head-mounted device 1100 that may be used to capture images or video of a scene and present the scene with augmented reality information to a user via the display 1140 disposed within the head-mounted device. The head-mounted device 1100 includes a camera 1103 having multiple sensors 1103a-c configured to provide image information to a scene sensor 1100, which provides the captured scene information to the software modules 1107 to determine information about the scene, such as identifying POIs, edge and other feature information in the scene. The module 1107 accesses the data store 1155 to access hierarchical cluster tree information and generate an augmented image to display on the devices display 1140 according to methods for hierarchical clustering for view management in augmented reality according to this disclosure.

Referring now to FIG. 12, FIG. 12 shows an example network that may be used in conjunction with various suitable devices or systems for hierarchical clustering for view management in augmented reality 1205a-c, 1260a-b, where any device presenting augmented reality views to a user may be coupled to other devices such as the devices shown in FIGS. 2-4. In one example, one or more devices, such as mobile device 1100 is connected to the network 1210. The mobile device 1100 is configured to access POI information or hierarchical cluster tree information from one or more data stores, such as databases 1220a-b. In some examples, devices may be configured to access the Internet to obtain relevant POI or hierarchical cluster tree information.

In some examples, a remote device with a camera, such as a smartphone, may be positioned within a scene and may capture images or videos of the scene and transmit the images or video over the network 1210 to a computing device, such as the computing device 900 shown in FIG. 9. The computing device 900 may then access hierarchical cluster tree information and generate an augmented image to display on the computing devices 900 display screen. One such example may enable a user of the computing device 900 to remotely obtain enhanced reality information of a scene. In some examples, the computing device may transmit augmented information back to the remote device, which the device may then display on its own local display. One such embodiment may enable a device with limited processing or storage capability to provide a augmented reality display of a scene to a user.

While the methods and systems herein are described in terms of software executing on various machines, the methods and systems may also be implemented as specifically-configured hardware, such as field-programmable gate array (FPGA) specifically to execute the various methods. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs for editing an image. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example computer-readable storage media, that may store instructions that, when executed by the processor, can cause the processor to perform the steps described herein as carried out, or assisted, by a processor. Examples of computer-readable media may include, but are not limited to, an electronic, optical, magnetic, or other storage device capable of providing a processor, such as the processor in a web server, with computer-readable instructions. Other examples of media comprise, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code for carrying out one or more of the methods (or parts of methods) described herein.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

What is claimed is:

1. A method comprising:
accessing point of interest (POI) metadata for a plurality of points of interest associated with a scene;
generating a hierarchical cluster tree for at least a portion of the POIs;
establishing a plurality of subdivisions associated with the scene;
selecting a plurality of POIs from the hierarchical cluster tree for display based on an augmented reality (AR) viewpoint of the scene, the plurality of subdivisions, and a traversal of at least a portion of the hierarchical cluster tree; and
displaying labels comprising POI metadata associated with the selected plurality of POIs, the displaying based on placements determined using image-based saliency.

2. The method of claim 1, wherein generating the hierarchical cluster tree is based on at least one of (1) a distance from the AR viewpoint; (2) a semantic similarity between metadata for at least two POIs; (3) a geometry of the scene; or (4) pre-selected weighting associated with categories of the point of interest metadata.

3. The method of claim 1, further comprising generating an edge map of a view of the scene from the AR viewpoint and identifying edge information for the view, wherein the placements are further determined based on the edge information.

4. The method of claim 1, further comprising:
determining a change in the AR viewpoint in the scene; and
updating the displaying of labels based on the change in the AR viewpoint.

5. The method of claim 4, wherein the updating the display of labels is based on a weight, the weight indicating a preference to maintain an AR node in a position relative to the scene.

6. The method of claim 1, further comprising:
determining an expiration of an update interval and a second AR viewpoint of the scene; and
updating the displaying of labels based on the second AR viewpoint.

7. The method of claim 1, further comprising:
receiving a selection of an AR node; and
updating the displaying of labels based on opening the selected AR node.

8. The method of claim 7, further comprising:
receiving a selection of the opened AR node, and
updating the displaying of labels based on closing the opened AR node.

9. The method of claim 1, wherein the selecting and displaying are performed in real-time or near-real-time.

10. The method of claim 1, wherein the subdivisions are of an output display space.

11. The method of claim 1, wherein the subdivisions are of real world space.

12. The method of claim 11, wherein generating a hierarchical cluster tree comprises associating coordinates in real world space with the POI metadata and wherein displaying the labels is based on the coordinates associated with the POI metadata.

13. The method of claim 1, further comprising determining a quantity of POIs associated with a subdivision exceeds a predetermined threshold, and collapsing one or more AR nodes associated with the POIs associated with the subdivision.

14. The method of claim 1, wherein generating the hierarchical cluster tree comprises accessing location-based information via a network connection, obtaining one or more POIs for a location, and determining the hierarchical clustering tee that based on the obtained one or more POIs.

15. The method of claim 1, further comprising shifting a location of at least one of labels away from a location or subdivision in which a corresponding POI is visible, and providing an indication to associate the at least one label with the placement of the corresponding POI.

16. The method of claim 1, wherein establishing the plurality of subdivisions comprises identifying a first POI, generating a first circular subdivision centered on the first POI, identifying a second POI, responsive to determining not to assign the second POI to the first circular subdivision, generating a second circular subdivision centered on the second POI.

17. A system comprising:
an optical sensor;
a processor in communication with the optical sensor, the processor configured to:
access point of interest (POI) metadata for a plurality of points of interest associated with a scene;
generate a hierarchical cluster tree for at least a portion of the POIs;
establish a plurality of subdivisions associated with the scene;
select a plurality of POIs from the hierarchical cluster tree for display based on an augmented reality (AR) viewpoint of the scene, the plurality of subdivisions, and a traversal of at least a portion of the hierarchical cluster tree; and
generate a display signal configured to display labels on a display screen based on placements determined using image-based saliency, the labels comprising POI metadata associated with the selected plurality of POIs; and
wherein the AR viewpoint is based on signals received from the optical sensor by the processor.

18. The system of claim 17, further comprising the display screen.

19. The system of claim 17, wherein the processor is further configured to generate the hierarchical cluster tree based on at least one of (1) a distance from the AR viewpoint; (2) a semantic similarity between metadata for at least two POIs; (3) a geometry of the scene; or (4) pre-selected weighting associated with categories of the point of interest metadata.

20. The system of claim 17, wherein the processor is further configured to generate an edge map of a view of the scene from the AR viewpoint and identifying edge information for the view, wherein the placements are further determined based on the edge information.

21. The system of claim 17, wherein the processor is further configured to:
receive a selection of an AR node; and
generate a second display signal configured to display labels on the display screen based on opening the selected AR node and placements determined using image-based saliency.

22. A non-transitory computer-readable medium comprising program code configured to cause a processor to execute a method, the program code comprising:
program code for accessing point of interest (POI) metadata for a plurality of points of interest associated with a scene;
program code for generating a hierarchical cluster tree for at least a portion of the POIs;
program code for establishing a plurality of subdivisions associated with the scene;
program code for selecting a plurality of POIs from the hierarchical cluster tree for display based on an augmented reality (AR) viewpoint of the scene, the plurality of subdivisions, and a traversal of at least a portion of the hierarchical cluster tree; and
program code for displaying labels comprising POI metadata associated with the selected plurality of POIs, the displaying based on placements determined using image-based saliency.

23. The non-transitory computer-readable medium of claim 22, wherein the program code for generating the hierarchical cluster tree comprises program code for generating the hierarchical cluster tree based on at least one of (1) a distance from the AR viewpoint; (2) a semantic similarity between metadata for at least two POIs; (3) a geometry of the scene; or (4) pre-selected weighting associated with categories of the point of interest metadata.

24. The non-transitory computer-readable medium of claim 22, further comprising:
program code for receiving a selection of an AR node; and
program code for updating the displaying of labels based on opening the selected AR node.

25. A system comprising:
means for accessing point of interest (POI) metadata for a plurality of points of interest associated with a scene;
means for generating a hierarchical cluster tree for at least a portion of the POIs;
means for establishing a plurality of subdivisions associated with the scene;
means for selecting a plurality of POIs from the hierarchical cluster tree for display based on an augmented reality (AR) viewpoint of the scene, the plurality of subdivisions, and a traversal of at least a portion of the hierarchical cluster tree; and
means for displaying labels comprising POI metadata associated with the selected plurality of POIs, the displaying based on placements determined using image-based saliency.

26. The system of claim 25, further comprising:
means for receiving a selection of an AR node; and
means for updating the displaying of labels based on opening the selected AR node.

27. The system of claim 26, further comprising:
means for receiving a selection of the opened AR node, and
means for updating the displaying of labels based on closing the opened AR node.

28. The system of claim 25, wherein the selecting and displaying are performed in real-time or near-real-time.

29. The system of claim 25, wherein the subdivisions are of an output display space.

30. The system of claim 25, wherein the subdivisions are of real world space.
